(19) United States
(12) Patent Application Publication
(10) Pub. No.: US 2024/0138316 A1
(43) Pub. Date: May 2, 2024

(54) AGRICULTURAL WAGON

(71) Applicant: Hustler Equipment Limited, Hastings (NZ)

(72) Inventors: Neville WARD, Ashburton (NZ); Brent Adrian CURRIE, Hastings (NZ)

(21) Appl. No.: 18/548,071

(22) PCT Filed: Feb. 25, 2021
(86) PCT No.: PCT/NZ2021/050024

§ 371 Date: Aug. 25, 2023

(51) Int. Cl. A01D 90/12; A01B 59/042; A01D 90/10

(52) U.S. Cl. CPC A01D 90/12; A01B 59/042; A01D 90/10

(57) ABSTRACT

An agricultural wagon having a plurality of load sensors between a tow bar and a chassis, the load sensors configured to sense the load on the wagon when it is supported on a tow coupling or on a stand. The agricultural wagon also has a collapsible cross conveyor, a lift-out tail gate and plastic hungry boards.

### FIELD

This invention relates to an agricultural wagon.

### BACKGROUND

Agricultural wagons are used to carry and feed out various materials, particularly loose (i.e. not baled) materials. For example, agricultural wagons can carry silage, meal, maize or magnesium, among other things.

### SUMMARY

According to one example embodiment there is provided an agricultural wagon comprising:
a wagon body;
a chassis configured to support the wagon body;
a tow bar coupled to the chassis;
a tow coupling on the tow bar; and
a plurality of load sensors, each positioned to sense a load between the tow bar and the chassis.

According to another example embodiment there is provided an agricultural wagon comprising:
a compartment configured to store material to be fed from the wagon;
a cross conveyor for feeding the material along a feed axis and out from the wagon, the feed axis extending laterally with respect to the wagon in use;
   wherein the cross conveyor has an extended configuration and a collapsed configuration, the length of the cross conveyor along the feed axis being greater in the extended configuration than in the collapsed configuration.

According to another example embodiment there is provided an agricultural wagon comprising:
a compartment configured to store material to be fed from the wagon; and
one or more extension boards each located on a side wall of the compartment;
   wherein the one or more extension boards is/are made of a plastics material.

According to another example embodiment there is provided an agricultural wagon comprising:
a compartment configured to store material to be fed from the wagon; and
a tail gate configured to form all or part of a rear wall of the compartment when installed on the wagon;
   wherein the wagon is configured such that the tail gate can be lifted to uninstall it from the wagon.

Embodiments may be implemented according to any one of the dependent claims 2 to 9, 11 to 19, 21 to 26 or 28 to 30.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e., they will be taken to mean an inclusion of the listed components which the use directly references, and possibly also of other non-specified components or elements.

Reference to any document in this specification does not constitute an admission that it is prior art, validly combinable with other documents or that it forms part of the common general knowledge.

### BRIEF DESCRIPTION OF THE DRAWINGS

The accompanying drawings, which are incorporated in and constitute part of the specification, illustrate embodiments of the invention and, together with the general description of the invention given above, and the detailed description of embodiments given below, serve to explain the principles of the invention.

FIG. 1 is an isometric view of an agricultural wagon according to one exemplary embodiment;

FIG. 2 is another view of the agricultural wagon of FIG. 1;

FIG. 3 is a side view of a tow assembly according to one exemplary embodiment;

FIG. 4 is another view of the agricultural wagon of FIG. 1 with a tail gate installed;

FIG. 5 is another view of the agricultural wagon of FIG. 1 with the tail gate uninstalled;

FIG. 6 is a view of the wagon of FIG. 1 with some components removed;

FIG. 7 is another view of the wagon of FIG. 1 with some components removed;

FIG. 8 is an isometric view of a cross conveyor according to one exemplary embodiment;

FIG. 9 is a side view of two coupled hungry boards according to one exemplary embodiment; and

FIG. 10 is a side view of two decoupled hungry boards according to one exemplary embodiment.

### DETAILED DESCRIPTION

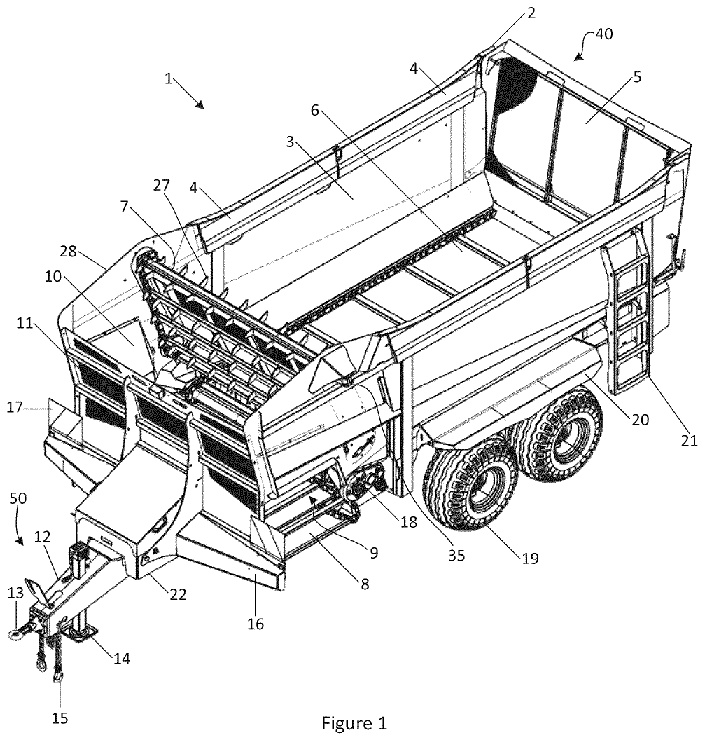

FIG. 1 illustrates an agricultural wagon 1 according to an example embodiment. In the description below, the agricultural wagon will be discussed in the context of feeding out silage, in which case it may be termed a silage wagon. However, this is only one exemplary use and the teachings of the present application are applicable to other kinds of agricultural wagons used for other purposes.

The agricultural wagon 1 has a main body, generally indicated at 40, and a tow assembly generally indicated at 50. The main body 40 can include a holding compartment 2 for receiving material such as silage as well as one or more conveyors for feeding out the material. The tow assembly 50 is used to couple the wagon to an agricultural vehicle such as a tractor. A chassis (the forward extension of which is visible at 22) supports the compartment 2 and other components of the main body. The tow assembly 50 is also connected to the main body 40 via the chassis 22.

The holding compartment 2 is formed by walls that prevent material from falling off the wagon 1. One or more of the walls can be fixed to the body 40. One or more of the walls can be removable or openable. One or more of the walls can include or be constituted by a conveyor. In this example, the compartment 2 is formed by fixed side walls 3, removable tail gate 5 and elevator 7. One or more extension boards can also be provided at the top of one or more of the walls. These may increase the carrying capacity of the wagon by raising the height of the walls and may be known in the industry as “hungry boards”. In the example of FIG. 1, the wagon has four hungry boards 4, two on each side wall 3.

The compartment 2 may have a conveyor in it to transfer material out of the compartment 2 or from one location in the compartment 2 to another. For example, the conveyor may be a screw auger or an endless loop-type conveyor. In the example of FIG. 1, the floor of the compartment 2 has a conveyor 6 in the form of a floor chain 6. This can be used to feed material forwards towards the elevator 7. The elevator 7 picks the material up from the compartment 2, raises it over the elevator 7 and deposits it onto the cross conveyor 8 in the feed out compartment 28. The elevator can have teeth 27 to assist in picking up the material and breaking up any large clumps of material. The conveyor 6 and elevator 7 can be driven by motors, for example hydraulic motors. The motor and gearbox for the floor conveyor is shown at 18. The motor for the elevator 7 is shown at 35.

The wagon 1 has an opening on one or more sides for allowing the material on the cross conveyor 8 to be fed out of the wagon. In the example of FIG. 1, the wagon 1 has two openings, one on each side of the wagon 1, although only one opening 9 is visible in FIG. 1. The cross conveyor 8 can be arranged to feed material out of either side of the wagon 1. An operator can select which direction the cross conveyor 8 transports material in based on which side of the wagon 1 they want to feed material out from. The cross conveyor 8 can also move laterally to control the lateral throw of material fed from the wagon 1. In one example, one or more hydraulic rams could be connected to the cross conveyor to move it laterally. The hydraulic rams could be controlled by a switch, button or other control device on the agricultural vehicle. The control device could be connected to the hydraulic rams by a hydraulic circuit and/or an electric circuit. The cross conveyor 8 can extend further out from the side of the wagon that it feeds material from. This may ensure that the material does not fall under the wheels 19. It may also help to feed material into troughs or to prevent material from being deposited onto a road or track that the wagon 1 travels on. In this example, the cross conveyor 8 extends outwards as far as the outer edges of the wheels 19, although it could extend further in other examples. One or more deflector plates 10 can be provided above the cross conveyor 8 in the feed out compartment 28. These may help to prevent material falling from the elevator out of the opening(s) 9, rather than being properly conveyed out of them by the cross conveyor 8. In particular, the deflector plate(s) can prevent material from falling out of the side other than the one that the cross conveyor 8 is feeding material out from. The deflector plates are placed above each opening to deflect falling material towards the middle of the cross conveyor 8. The deflector plates 10 can extend inwards at least to a point above the outermost end of the cross conveyor 8 so that there is no direct vertical path from the elevator 7 past the deflector plate 10 and out of the opening 9.

The deflector plates 10 could be fixed in place over the cross conveyor or could be movable. For example, the deflector plates 10 could be hinged to the side of the wagon so that they can be folded away when not needed. In another example, the deflector plate(s) 10 could move with the cross conveyor 8. The lower end of the movable deflector plate(s) 10 could be coupled to the cross conveyor 8 by one or more link arms that are pivotably connected to the cross conveyor 8 or to the deflector plate(s) 10. The upper end of the deflector plate(s) could be slidably connected to the side of the wagon. In this arrangement, when the cross conveyor 8 moves laterally towards one side (the feeding side) the lower end of the deflector plate 10 at the other side (the non-feeding side) will be pulled towards the feeding side. The upper end of the deflector plate will slide downwards to allow the lower end of the plate to move towards the feeding side. This can ensure that the deflector plate at the non-feeding side adequately covers the opening at the non-feeding side. This arrangement may be particularly useful when the cross conveyor 8 can move a long way towards the feeding side.

The wagon 1 can also have a front wall 11 that is located across the cross conveyor from the elevator 7. The front wall 11, elevator 7 and side walls 3 provide the sides of the feed out compartment 28. The front wall 11 can be a solid wall or it can have one or more holes in it. Holes may allow an operator on the agricultural vehicle to see into the wagon 1 to monitor its operation and to check on the amount of material in the wagon 1. Alternatively, the front wall 11 may be made of a transparent material, for example a tough plastic such as polycarbonate or acrylic. In the example of FIG. 1, the front wall has mesh panels which provide many small holes for the operator to look through. The tail gate 5 may similarly be formed of a solid wall or may have holes, and it may be formed of transparent material, for example a tough plastic such as polycarbonate or acrylic. In this example, the tail gate 5 also has mesh panels. These examples may allow an operator on the agricultural vehicle to see through the tail gate 5 behind the wagon.

The tow assembly 50 includes a tow bar 12. The tow bar 12 is connected to the chassis of the wagon 1. A tow coupling 13 is provided on the tow bar 12 for coupling the wagon to the agricultural vehicle. The tow assembly 50 also includes a stand 14 to help support the wagon 1 when it is not coupled to the agricultural vehicle. The stand is connected to the tow bar 12. One or more chains 15 may also be provided as a secondary means of coupling the wagon 1 to the agricultural vehicle.

The agricultural wagon 1 can have protective members such as bumpers or nerf bars for protection. In the example of FIG. 1, nerf bars 16 are fitted to the front of the body 40 of the wagon 1 near the cross conveyor 8. These may be particularly useful in protecting the wagon from damage that could otherwise be caused if the wagon were to jack-knife while connected to the agricultural vehicle. Visual indicators 17 can also be provided on the front of the wagon to improve visibility of the front the wagon and help an operator on the agricultural vehicle to judge the position of the front of the wagon 1. The indicators may be brightly coloured and may have a striking design on them.

The wagon 1 also has a guard 20 over the wheels 19. This may act as a mud guard. The guard may also act a step for an operator to stand on, for example to inspect or access the interior of the holding compartment 2 or to install or remove the hungry boards 4. A ladder 21 is also provided on the side of the wagon 1 for accessing the compartment 2 and hungry boards 4.

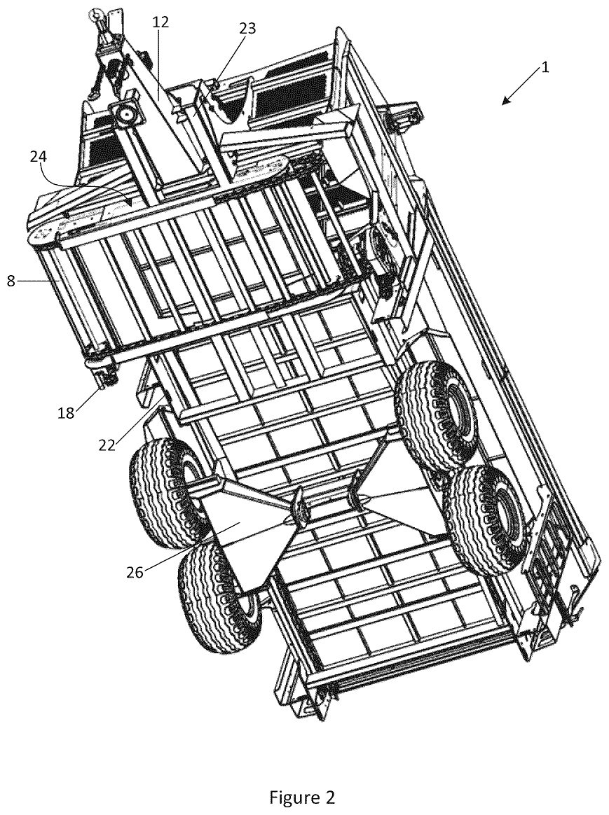

FIG. 2 shows the underside of the agricultural wagon 1. The chassis 22 that supports the main body of the wagon can be seen better in this view. The chassis 22 includes bars 23 that extend forwards to connect to the tow bar 12. The bars 23 can extend through an opening 24 in the cross conveyor 8. This saves space and improves ground clearance beneath the wagon 1.

Also shown in FIG. 2 are the axle support subframes 26. These are mounted beneath the chassis 22 and support the wheels. The motor 18 for driving movement of the cross conveyor 8. The direction of operation of the motor can be reversed to change which side of the wagon material is fed from. One or more load sensors can be provided in the axle support subframes 26 or between the subframes 26 and the chassis 22 to measure the load of the wagon on the wheels 19.

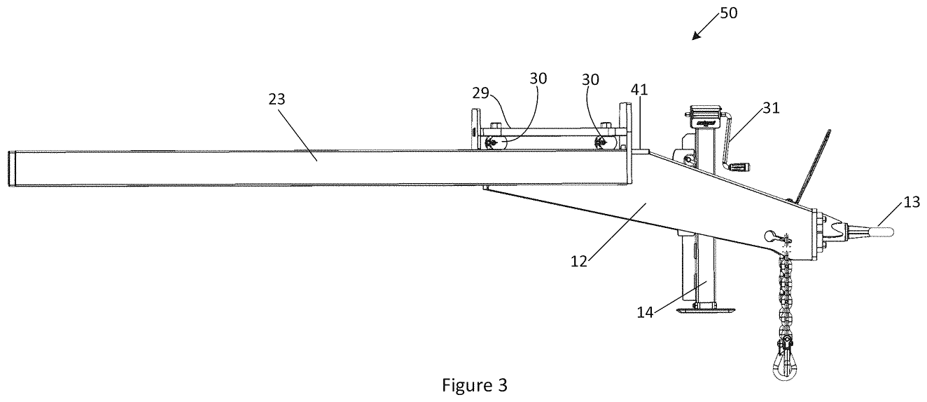

FIG. 3 shows the tow assembly 50 in more detail. As shown in this figure, two load sensors 30 are provided in the tow assembly 50. These are used to measure the load on the wagon. In one example, the load sensors 30 are load cells. The tow bar 12 can be connected to the chassis with the load sensors 30 between the tow bar 12 and the chassis. In the example of FIG. 3, the tow bar 12 includes a mounting plate 41 and the chassis includes a mounting plate 29 on the ends of the bars 23. The mounting plates 29 and 41 are bolted to each other via the load sensors 30.

The load sensors 30 are each configured to sense a load between the tow bar 12 and the chassis. The combination of the outputs of the load sensors 30 can be used to determine the load of the wagon. The outputs of the load sensors 30 may be combined with measurements of the load on the wheels, for example from load sensors in the subframes (item 26 in FIG. 2) or between the subframes and the chassis (item 22 in FIG. 2). In one example, the sum of the outputs of the load sensors represents the full load of the wagon. Depending on the type of sensors used and their configurations, the sensor outputs may be combined in other ways to represent the load on the wagon, for example by subtracting one or more outputs from the other(s) and/or by multiplying one or more outputs by a coefficient before summing them. The combination of outputs may be performed logically in a computing device or the outputs may be combined physically. For example, the load sensor outputs could be voltages which are combined in parallel to produce a combined output. Alternatively, the load sensor could employ a hydraulic fluid in the sensing element that is pressurized dependent on the force applied to it, in which case the hydraulic fluids could be in a common fluid circuit so that the fluid pressure is dependent on the forces on both load sensors. In this example, the load sensors 30 are load cells that are electrically connected in parallel and each output a voltage that is proportional to the force applied to it. The voltages of the two load cells combine in parallel to produce a total voltage that represents the total load on the load cells and the total load of the wagon.

The output from the load sensors 30 can be provided to load-sensing circuitry of the wagon. Alternatively, the output of the load sensors can be provided to the load-sensing circuitry on the agricultural vehicle via an electrical connection between the wagon and the vehicle. The load sensors and/or the load-sensing circuitry can be arranged, calibrated or programmed to determine the gross weight of the wagon, taking into account the weight of a load in the compartment and the wagon itself, or the net weight of the load not including the weight of the wagon itself. The load-sensing circuitry may be a computing device such as a processor or microcontroller. The load-sensing circuitry may be dedicated to the task of sensing wagon loads or could be used for other operations. For example, the on-board computer and/or monitoring circuit of the agricultural vehicle may be used as the load-sensing circuitry.

The use of two load sensors 30 in the tow assembly may allow the weight of the wagon to be determined when the wagon is supported by the tow coupling 13 or a stand (such as the jack 14) without the need to recalibrate the sensors or change a calculation performed by a computing device. Whether the wagon is on the tow coupling 13 or the stand, the combined output of the two load sensors 30 will be the same.

Further load sensors could be provided between the tow bar 12 and the chassis 22 for added redundancy or for weighing greater loads. One or more additional load sensors may be provided in other parts of the agricultural wagon, for example between the floor of the compartment and the chassis 22.

As shown in FIG. 3, the stand is a jack 14 that has a crank handle 31 for extending and retracting the jack 14.

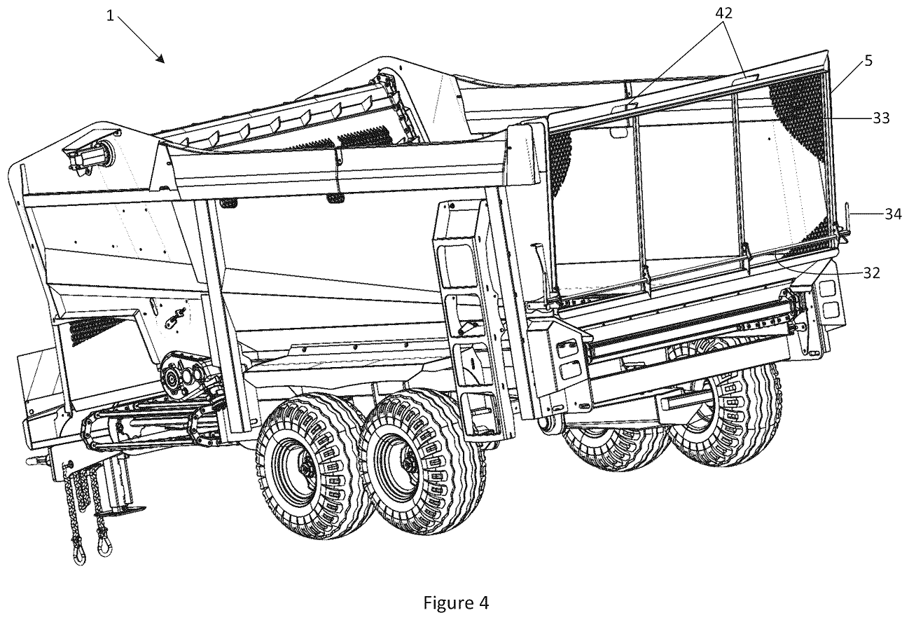

The tail gate 5 is shown installed on the wagon 1 in FIG. 4. The tail gate 5 can be uninstalled from the wagon 1 by lifting. For example, the tail gate 5 can be lifted from its place on the wagon by a tractor, a forklift, a winch etc. The tail gate 5 has holes 42 formed in it to receive fork tines. For example, a forklift can insert fork tines into the holes 42 and lift them to uninstall the tail gate 5. The tail gate 5 can also be installed by lowering it into place. For example, a forklift can carry the tail gate 5 on its forks and lower the forks to lower the tail gate 5 into place on the wagon, before reversing to remove its fork tines from the holes 42.

Guides, runners, rails or the like may be provided in the side walls of the wagon 1 to engage with edges of the tail gate 5 and help to guide it into place during installation and control its withdrawal during uninstallation.

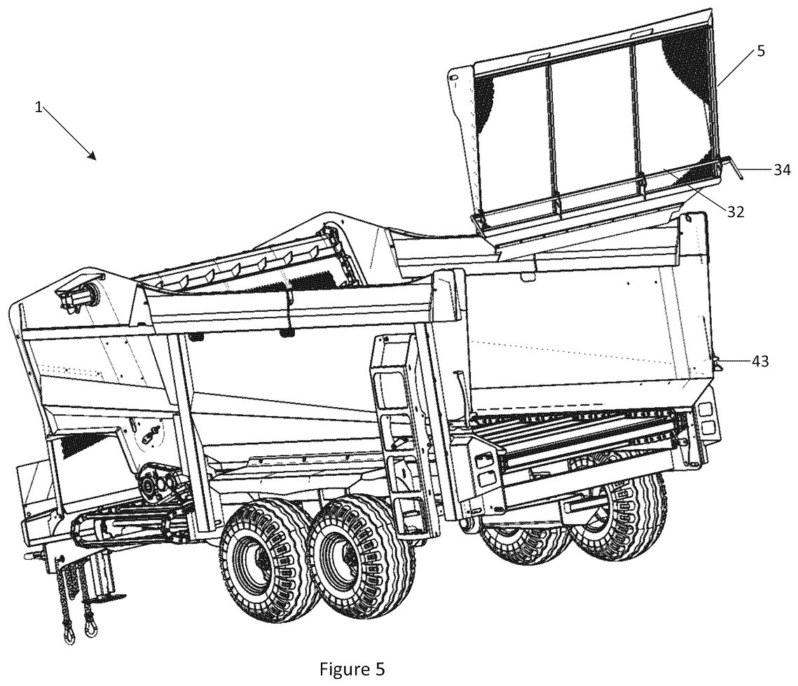

A locking bar 32 can be provided to lock the tail gate 5 into place when it is installed. This can be provided with one or more handles 34 for unlocking and locking the tail gate 5 by hand. Any other suitable lock could be provided to retain the tail gate 5 when installed. FIG. 5 shows the tail gate 5 in a lifted position. As can be seen, the handle 34 of the locking bar 32 has been turned to release it from the catch 43, allowing the tail gate 5 to be removed.

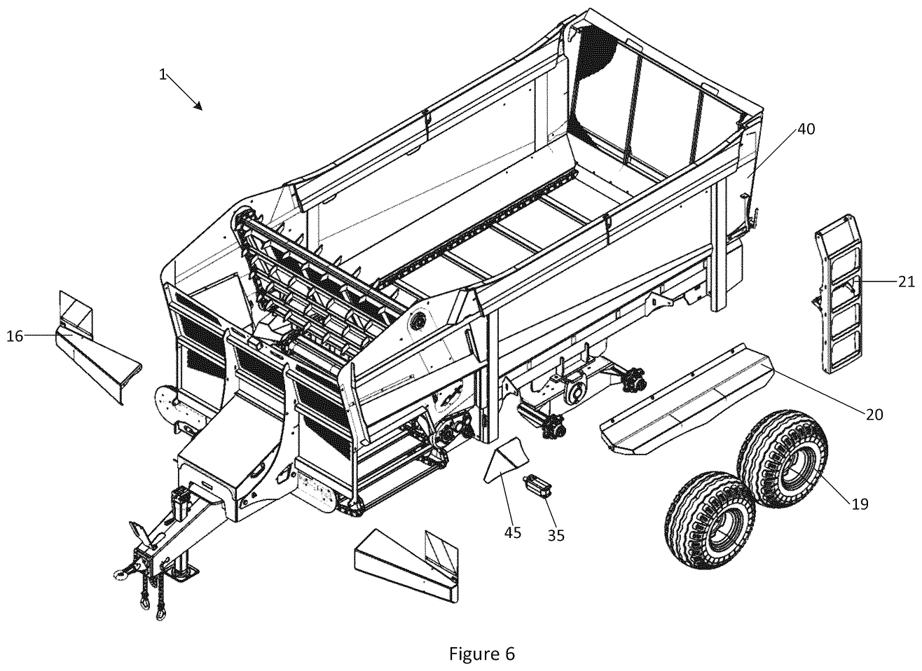

In FIGS. 6 and 7, some components of the wagon 1 have been removed from the main body 40 of the wagon 1. This may help to allow the main body 40 of the wagon 1 to fit withing a standard size shipping container. Specifically, the nerf bars 16, wheels 19, wheel guard 20, elevator motor 35, motor guard 45 and ladder 21 have been removed from the main body 40. For transport, these components (and any other removed or not attached components) could be placed in the compartment (labelled 2 in FIG. 1) or shipped separately.

It can be seen in FIG. 7 that the cross conveyor 8 extends out from the side of the main body of the wagon 1. This may be advantageous for feeding out of material like silage. In this extended configuration, the length of the cross conveyor can be such that it extends beyond one or both sides of the main body 40. For transport, it may be advantageous for the cross conveyor to not extend beyond the sides of the main body 40. The cross conveyor can be collapsible to reduce its length as measured along a feed axis, i.e. the left-right axis in the view of FIG. 7. In the collapsed configuration, the cross conveyor does not extend beyond the sides of the main body 40. This may help allow the main body 40 to fit in a standard shipping container.

For shipping, the wagon 1 could be prepared with attachments (e.g. 16, 19, 20, 35, 45 and 21 shown in FIG. 6) detached from the main body and safely packaged in the holding compartment. The cross conveyor would also be in the retracted configuration. After shipping, the attachments can be attached to the main body and the cross conveyor 8 can be put into the extended configuration.

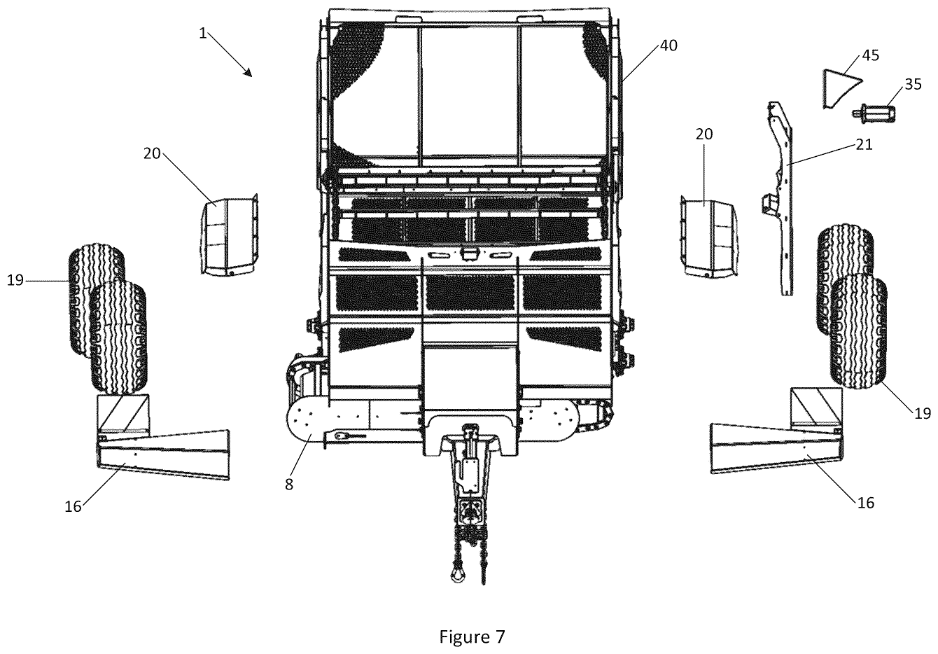

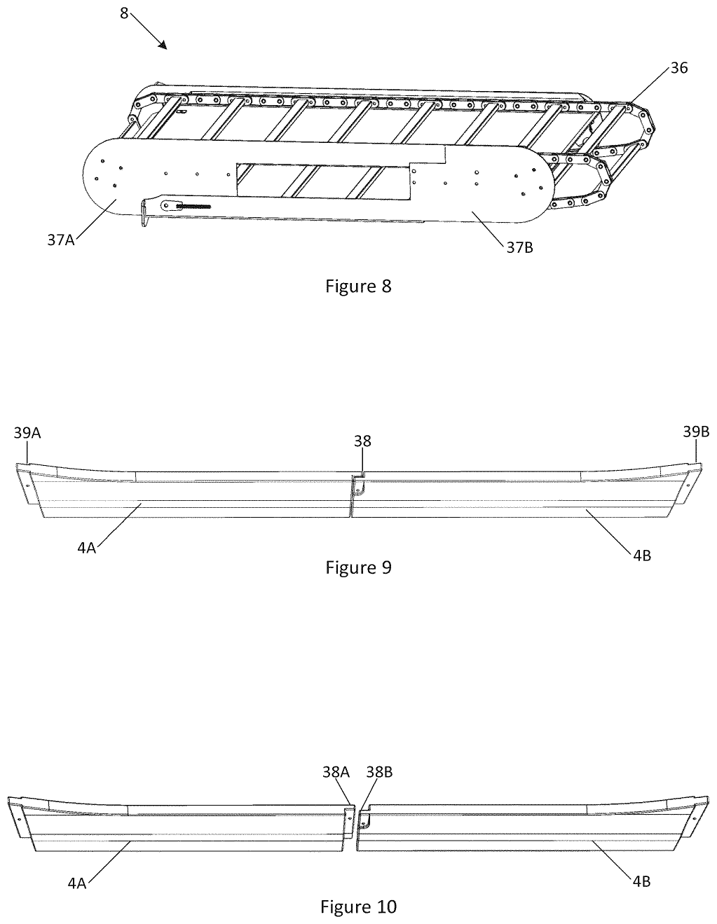

The cross conveyor 8 is shown in isolation in FIG. 8. The cross conveyor 8 includes two frame halves 37A and 37B. The cross conveyor 8 also includes a conveyor chain 36.

In this example, the frame halves can slide towards each other to move the cross conveyor 8 from the extended configuration shown into the retracted configuration. In other examples, the cross conveyor could include other collapsible structures such as several bars with chain supports on them, where the bars can slide towards and away from each other to collapse and extend the cross conveyor.

Two hungry boards 4A and 4B are shown in each of FIGS. 9 and 10. The hungry boards can be made of a plastics material. In one example, the material is high-density polyethylene (e.g. PE100). The two hungry boards 4A and 4B can be provided on the same wall of the wagon and can couple to each other to form a continuous barrier. The hungry boards 4A and 4B can be the same shape as each other. This means that any two hungry boards can be put together to make the barrier on the side wall. In this example, the hungry boards are configured to be coupled to each other and used on the same side of the wagon when they are oriented at 180° to each other.

The hungry boards 4A and 4B have couplings 39A and 39B at their outer ends for coupling to the sides of the wagon. The two hungry boards 4A and 4B in this example couple to each other at the coupling 38. As shown in FIG. 10, the coupling 38 is formed between the L-shaped mating ends 38A and 38B of the hungry boards.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described.

Accordingly, departures may be made from such details without departure from the spirit or scope of the Applicant's general inventive concept.

1. An agricultural wagon comprising:
a wagon body;
a chassis configured to support the wagon body;
a tow bar coupled to the chassis;
a tow coupling on the tow bar; and
a plurality of load sensors, each positioned to sense a load between the tow bar and the chassis.

2. The agricultural wagon of claim 1, further comprising load sensing circuitry configured to determine a load of the wagon based on a combination of the outputs of the load sensors.

3. The agricultural wagon of claim 2, wherein the load sensing circuitry is configured to determine the load of the wagon based on a sum of the outputs of the load sensors.

4. The agricultural wagon of claim 1, further comprising a stand on the tow bar for supporting the wagon.

5. The agricultural wagon of claim 4, wherein the load sensors are configured to sense the load between the tow bar and the chassis when the wagon is supported by the tow coupling and/or the stand.

6. The agricultural wagon of claim 5 wherein the stand is a jack stand.

7. The agricultural wagon of claim 1 wherein the load sensors are load cells.

8. The agricultural wagon of claim 2 wherein the load sensing circuitry is configured to determine the weight of a load carried by the agricultural wagon or the total weight of the agricultural wagon plus a load carried by the wagon based on the outputs of the load sensors.

9. The agricultural wagon of claim 1, wherein the load sensors are electrically connected in parallel.

10. An agricultural wagon comprising:
a compartment configured to store material to be fed from the wagon;
a cross conveyor for feeding the material along a feed axis and out from the wagon, the feed axis extending laterally with respect to the wagon in use;
wherein the cross conveyor has an extended configuration and a collapsed configuration, the length of the cross conveyor along the feed axis being greater in the extended configuration than in the collapsed configuration.

11. The agricultural wagon of claim 10, wherein the wagon comprises a main body and the cross conveyor, the main body comprising:
the compartment; and
a chassis configured to support the compartment and the cross conveyor.

12. The agricultural wagon of claim 11 wherein in the extended configuration the cross conveyor extends laterally beyond one or both side(s) of the main body.

13. The agricultural wagon of 12 wherein in the collapsed configuration the cross conveyor does not extend laterally beyond either side of the main body.

14. The agricultural wagon of claim 10 wherein the agricultural wagon is configured to fit within a standard shipping container when the cross conveyor is in the collapsed configuration.

15. The agricultural wagon of claim 10 further comprising one or more attachments configured to attach to the main body, wherein the attachment(s) is/are removable and the agricultural wagon is configured to fit within a standard shipping container when the attachment(s) is/are removed.

16. The agricultural wagon of claim 10 wherein the cross conveyor is configured to feed material from a first side of the agricultural wagon in a first mode of operation and from a second side of the agricultural wagon in a second mode of operation.

17. The agricultural wagon of claim 16 wherein the cross conveyor is movably mounted to the agricultural wagon so that it can move towards the first side of the agricultural wagon in the first mode of operation and towards the second side of the agricultural wagon in the second mode of operation.

18. The agricultural wagon of claim 16 further comprising a deflector plate above the cross conveyor towards each side of the agricultural wagon to deflect material falling towards the end of the cross conveyor from which material is not fed towards the middle of the cross conveyor.

19. The agricultural wagon of claim 10 wherein a part of a chassis of the agricultural wagon passes through the cross conveyor.

20. An agricultural wagon comprising:
a compartment configured to store material to be fed from the wagon; and
one or more extension boards each located on a side wall of the compartment;
wherein the one or more extension boards is/are made of a plastics material.

21. The agricultural wagon of claim 20 wherein the plastics material is high-density polyethylene (HDPE).

22. The agricultural wagon of claim 20, wherein there are two extension boards on the same side wall.

23. The agricultural wagon of claim 20 wherein the extension boards are all the same shape.

24. The agricultural wagon of claim 23 wherein each extension board has a mating end that is configured to mate with a similar mating end of another extension board.

25. The agricultural wagon of claim 24 wherein the mating end and similar mating end have the same shape and are configured to mate when oriented at 180° to each other.

26. The agricultural wagon of claim 25 wherein the mating end and similar mating end are L shaped.

27. (canceled)

28. (canceled)

29. (canceled)

30. (canceled)
